(19) United States
(12) Patent Application Publication
(10) Pub. No.: US 2002/0021637 A1
(43) Pub. Date: Feb. 21, 2002

(54) Recording apparatus, recording medium, reading apparatus, and recording medium determination method

(75) Inventors: Michihiko Iida, Kanagawa (JP); Hiroyuki Hasegawa, Kanagawa (JP); Eiji Kumagai, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SONY CORPORATION, Shinagawa-ku (JP)

(21) Appl. No.: 09/900,918

(22) Filed: Jul. 10, 2001

(30) Foreign Application Priority Data
Jul. 11, 2000 (JP) 2000-215861

(51) Int. Cl. G11B 7/00

(52) U.S. Cl. 369/47.39; 369/53.22

(57) ABSTRACT

When a unique ID (identification information) is recorded on a loaded disk, the unique ID is recorded in a state in which the write clock is made to be 1/N so that the unique ID is recorded at a line density differing from that of another piece of information. Alternatively, as for writing control when recording a unique ID, the number of rotations of a disk is made to be N times greater. During reading, the unique ID is read by making the clock to be 1/N or by making the number of rotations of the disk to be N times, and the type of disk is determined on the basis of whether or not the unique ID could be read.

### BACKGROUND OF THE INVENTION

1. Field of the Invention

The present invention relates to a recording apparatus, a recording medium, a reading apparatus, and a recording medium determination method.

2. Description of the Related Art

Recently, with an increase in the recording capacity of disk-shaped recording media, it has become possible to record, in addition to audio data such as music, for example, video data such as movies.

When disk-shaped recording media are put in the market in a state in which, for example, copyrighted movies or music are recorded on such a disk, it is necessary to make a differentiation from the disks for which there is no copyright.

For this purpose, for example, when data is to be read from a disk, there has been a demand for making a disk determination on the basis of predetermined identification information recorded on the disk so that the type of disk is determined.

### SUMMARY OF THE INVENTION

In one aspect, the present invention a recording apparatus comprising: recording means for recording identification information of a recording medium in a predetermined area of the loaded recording medium; and recording control means for performing control such that the identification information is recorded at a line density differing from that of another piece of information recorded in another area.

In another aspect, the present invention a recording apparatus comprising: a recording head for recording information on a disk-shaped recording medium which is loaded; a spindle motor for driving the disk-shaped recording medium to rotate; and a recording controller for performing control such that the identification information of the recording medium is recorded, in a predetermined area of the disk-shaped recording medium, at a line density differing from that of other information which is recorded in another area.

In another aspect, the present invention provides a recording medium, in which identification information having a line density differing from that of information recorded in another area is recorded in a predetermined recording area.

In another aspect, the present invention provides a reading apparatus comprising: reading means for reading identification information recorded in a predetermined recording area of a loaded recording medium; reading control means for performing reading control corresponding to a line density at which the identification information is recorded when the identification information is read; reading determination means for determining whether or not the identification information could be read by predetermined reading control; and type determination means for determining the type of the recording medium on the basis of the determination result of the reading determination means.

In another aspect, the present invention provides a reading apparatus comprising: reading means for reading identification information recorded in a predetermined recording area of a loaded recording medium; signal generation means for generating a signal based on the period of information which is read from the recording medium; detection means for detecting the period of a signal generated by the signal generation means when the identification information is being read; density determination means for determining a line density at which the identification information is recorded on the basis of the detection result of the detection means; and type determination means for determining the type of the recording medium on the basis of the determination result of the density determination means.

In another aspect, the present invention provides a reading apparatus comprising: a reading head for reading information recorded on a loaded recording medium; a detector for detecting the recording line density of information recorded in a predetermined recording area of the recording medium in accordance with a reading signal of the head; and type determination means for determining, on the basis of the detection result of the detector, the line density of recording medium identification information which is prerecorded in an area provided in an inner radial portion of a lead-in area of the recording medium and for determining the type of the recording medium.

In another aspect, the present invention provides a recording medium determination method comprising: an access step for accessing a predetermined recording area of a loaded recording medium; a reading control step for performing reading control corresponding to a line density of identification information recorded in the predetermined recording area; a reading step for reading the identification information in a state in which the reading control is being performed; and a type determination step for determining the type of recording medium on the basis of whether or not the identification information could be read.

In another aspect, the present invention provides a recording medium determination method comprising: an access step for accessing a predetermined recording area of a loaded recording medium; a reading step for reading identification information recorded in the predetermined area; a detection step for detecting the period of the identification information; a line density determination step for determining a line density at which the identification information is recorded on the basis of the period; and a type determination step for determining the type of the recording medium on the basis of the line density.

According to the present invention, since identification information can be recorded in a predetermined area of a loaded recording medium at a line density different from that of data recorded in another area, a construction which does not need a data modulation circuit for recording identification information can be adopted.

Also, it becomes possible to cause a reading apparatus into which a recording medium is loaded to determine the type of the recording medium on the basis of the identification information recorded on the recording medium.

In addition, when identification information recorded in a predetermined recording area of a recording medium is to be read, reading control corresponding to a line density at which the identification information is recorded is performed, and the type of recording medium can be determined on the basis of whether or not the identification information could be read. This makes it possible to adopt a construction which does not require a data demodulation circuit for reading the identification information.

The above and further objects, aspects and novel features of the invention will become more fully apparent from the following detailed description when read in conjunction with the accompanying drawings.

### BRIEF DESCRIPTION OF THE DRAWINGS

FIG. 1 is a block diagram illustrating an example of the construction of a disk drive unit according to an embodiment of the present invention;

FIG. 2 is a block diagram illustrating an example of the construction of a PLL (phase-locked loop) circuit shown in FIG. 1;

FIG. 3A is a diagram showing a standard-density disk according to the embodiment; and FIG. 3B is a diagram showing a high-density disk according to the embodiment;

FIG. 4 is a table of information about a high-density disk and a standard-density disk according to the embodiment;

FIG. 5 is an illustration of a disk layout;

FIG. 6 is a table of information about a unique disk ID area;

FIG. 7 is an illustration of the frame structure of a disk according to the embodiment;

FIG. 8A is an illustration of a subcoding frame of one block of the disk according to the embodiment;

FIG. 8B is an illustration of Q-channel data according to the embodiment;

FIG. 9 is a flowchart illustrating an example of a processing step in a case where a unique ID is recorded;

FIG. 10 is a flowchart illustrating an example of a processing step in a case where a unique ID is recorded;

FIG. 11 is a flowchart illustrating an example of a processing step for performing a disk determination by reading a unique ID recorded on a disk; and

FIG. 12 is a flowchart illustrating an example of a processing step for performing a disk determination by reading a unique ID recorded on a disk.

### DESCRIPTION OF THE PREFERRED EMBODIMENTS

The preferred embodiments of the present invention will now be described below in the following sequence:

1. The construction of a disk drive unit

2. The type of disk of a CD format

3. Recording area format

4. Subcode and TOC

5. Recording of unique ID

6. Reading of unique ID

1. The Construction of a Disk Drive Unit

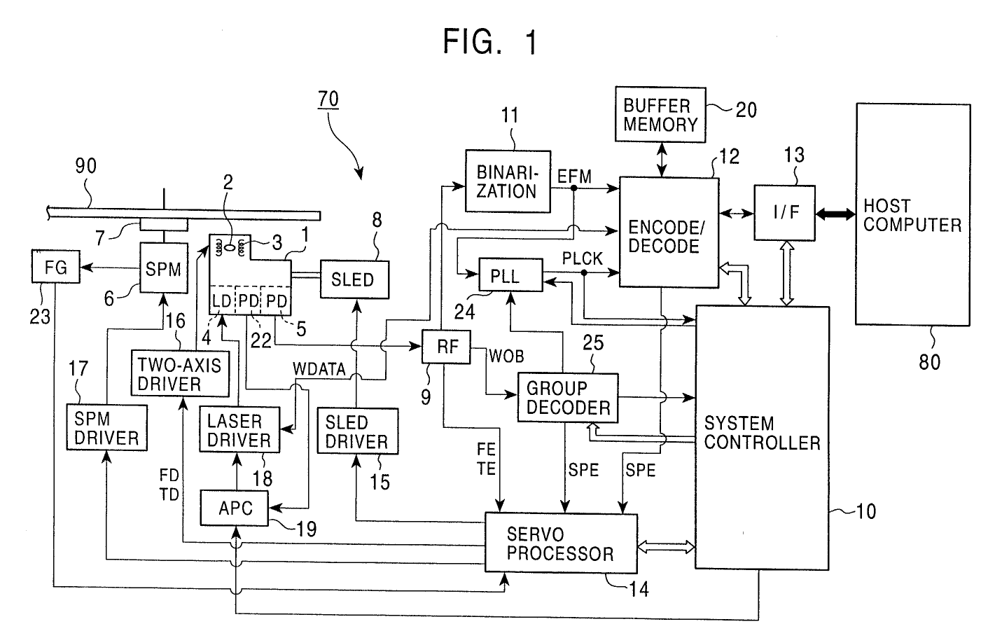

FIG. 1 shows the construction of a disk drive unit.

In FIG. 1, a disk 90 is a disk in a CD (Compact Disc) format, such as CD-R (Recordable), CD-RW (Rewritable), CD-DA (Digital Audio), or CD-ROM.

The disk 90 is placed on a turntable 7, and is driven to rotate at a constant linear velocity (CLV) or at a constant angular velocity (CAV) by a spindle motor 6 during a recording/reading operation. Then, pit data on the disk 90 is read by an optical pickup 1. Pits are pits formed by a phase change in the case of CD-RWs, are pits formed by an organic pigment change (reflectivity change) in the case of CD-Rs, and are embossed pits in the case of CD-DAs and CD-ROMs.

Inside the optical pickup 1, a laser diode 4 which serves as a laser light source, a photodetector 5 for detecting reflected light, an objective lens 2 which becomes an output end of the laser light, and an optical system (not shown) for irradiating the disk recording surface with laser light via the objective lens 2 and for guiding the reflected light to the photodetector 5 are formed. A monitoring detector for receiving a part of the light output from the laser diode 4 is also provided.

The objective lens 2 is held in such a manner as to be movable in the tracking direction and in the focusing direction by a two-axis mechanism 3. Also, the entire optical pickup 1 is made movable in the radial direction of a disk by a sled mechanism 8. Furthermore, the laser diode 4 in the optical pickup 1 is driven to emit light in accordance with a driving signal (driving current) from a laser driver 18.

The reflected light information from the disk 90 is detected by the photodetector 5, is converted into an electrical signal according to the amount of received light, and is supplied to an RF amplifier 9.

When the disk 90 is a recordable disk, the amount of reflected light from the disk 90 greatly varies from that when the disk 90 is a read-only disk depending on before, after, or during recording. Furthermore, due to the situation in which, in the CD-RW, reflectivity itself greatly varies from that of CD-ROMs and CD-Rs, generally, an AGC (automatic gain control) circuit is mounted in the RF amplifier 9.

The RF amplifier 9 comprises a current/voltage conversion circuit in such a manner as to correspond to the output current from a plurality of light-receiving elements as the photodetector 5, a matrix computation/amplifying circuit, etc., and generates a necessary signal by a matrix computation process. For example, an RF signal which is read data, a focusing error signal FE for servo control, a tracking error signal TE, etc., are generated.

The regenerated RF signal output from the RF amplifier 9 is supplied to a binarization circuit 11, and the focusing error signal FE and the tracking error signal TE are supplied to a servo processor 14.

On the disk 90 as a CD-R or a CD-RW, grooves which become guides for recording tracks are formed in advance, and moreover, the grooves are made to wobble (meander) in accordance with a signal such that time information indicating an absolute address on the disk is FM-modulated. Therefore, during a recording/reading operation, it is possible to apply tracking servo on the basis of groove information, and it is possible to obtain an absolute address and various other pieces of physical information as wobble information of the groove. The RF amplifier 9 extracts wobble information WOB by a matrix computation process and supplies it to a groove decoder 23. The absolute time (address) information represented by such wobbled grooves is called “ATIP” (Absolute Time in Pregroove).

The groove decoder 23 demodulates the supplied wobble information WOB in order to obtain the absolute address information, and supplies it to a system controller 10. Also, by inputting the groove information to the PLL circuit, the rotational speed information of the spindle motor 6 is obtained, and by comparing the information with reference speed information, a spindle error signal SPE is generated and is output. An FG 23 generates a frequency pulse corresponding to the rotational speed of the spindle motor 6 and supplies it to the servo processor 14.

A regenerated RF signal obtained by the RF amplifier 9 is converted into a commonly called EFM signal (8-14 modulation signal) as a result of being binarized by the binarization circuit 11, and this is supplied to an encoding/decoding section 12. The encoding/decoding section 12 comprises a functional portion as a decoder during reading and a functional portion as an encoder during recording.

During reading, as a decoding process, a process, such as EFM demodulation, CIRC (Cross Interleave Read-Solomon Code) error correction, deinterleaving, or CD-ROM decoding, is performed to obtain read data which is converted into CD-ROM format data. Also, the encoding/decoding section 12 performs a process of extracting subcode on the data read from the disk 90, and supplies the TOC as subcode (Q data), address information, etc., to the system controller 10.

A PLL circuit 24 generates a required clock in accordance with a binarized read signal (EFM signal, or EFM+signal) binarized by the binarization circuit 11, and supplies it to the encoding/decoding section 12. Then, the encoding/decoding section 12 performs EFM demodulation, an error-correction process, etc. in accordance with the clock from the PLL circuit 24.

Furthermore, during reading, the encoding/decoding section 12 causes the data decoded in the above-described manner to be accumulated in a buffer memory 20.

As for the read output from this disk drive unit, data which is buffered in the buffer memory 20 is read and transferred.

An interface section 13 is connected to an external host computer 80, and performs communication of recording data, read data, various commands, etc., to and from the host computer 80. In practice, SCSI, ATAPI (AT attachment packet interface), etc., is adopted. During reading, the read data which is decoded and stored in the buffer memory 20 is transferred to the host computer 80 via the interface section 13. A read command, a write command, and other signals from the host computer 80 are supplied to the system controller 10 via the interface section 13.

On the other hand, during recording, recording data (audio data or CD-ROM data) is transferred from the host computer 80. The recording data is sent from the interface section 13 to the buffer memory 20 and is buffered therein.

In this case, as a process for encoding the buffered recording data, the encoding/decoding section 12 performs a process for encoding CD-ROM format data into CD format data (when the supplied data is CD-ROM data), CIRC encoding and deinterleaving, subcode addition, EFM modulation, etc. The encoding process at this time is performed in accordance with a clock PLCK supplied from the PLL circuit 24.

The EFM signal obtained by the encoding process in the encoding/decoding section 12 is sent as a laser driving pulse (write data WDATA) to the laser driver 18. Recording compensation, that is, fine tuning of the optimum recording power with respect to the characteristics of a recording layer, the spot shape of the laser light, a recording linear velocity, etc., and a process for adjusting a laser driving pulse waveform, etc., are performed on the write data WDATA supplied to the laser driver 18.

The laser driver 18 supplies the laser driving pulse supplied as the write data WDATA to the laser diode 4 so that a driving of laser light-emission is performed. As a result, pits (phase-change pits or pigment-change pits) corresponding to the EFM signal are formed on the disk 90.

In this embodiment, when a predetermined unique ID is recorded on a unique disk ID area (to be described later), recording is performed at a line density different from that of other data. For example, in this embodiment, the unique ID can be recorded in such a way that the line density becomes 1/N, that is, the line density becomes lower than that of the normal data. Therefore, when the unique ID is to be recorded, the clock PLCK of the PLL circuit 24 is frequency-divided into 1/N that of a case where another recording is performed, and recording control is performed in accordance with this frequency-divided clock PLCK.

An APC (Auto Power Control) circuit 19 is a circuit section for performing control so that the output of a laser becomes constant regardless of the temperature while monitoring the laser output power in accordance with the output of the monitoring detector 22. The laser output target value is supplied from the system controller 10, and the laser driver 18 is controlled so that the laser output level reaches the target value.

The servo processor 14 generates various servo driving signals for focusing, tracking, sled control, and spindle control, on the basis of the focusing error signal FE and the tracking error signal TE from the RF amplifier 9, the spindle error signal SPE from the encoding/decoding section 12 or a groove decoder 25, etc., so that a servo operation is performed.

More specifically, a focusing driving signal FD and a tracking driving signal TD are generated in accordance with the focusing error signal FE and the tracking error signal TE, respectively, and are supplied to a two-axis driver 16. The two-axis driver 16 drives the focusing coil and the tracking coil of the two-axis mechanism 3 in the optical pickup 1. As a result, a tracking servo loop and a focusing servo loop by the optical pickup 1, the RF amplifier 9, the servo processor 14, the two-axis driver 16, and the two-axis mechanism 3 are formed.

The tracking servo loop is deactivated in accordance with a track jump instruction from the system controller 10, and a jump driving signal is output to the two-axis driver 16, so that a track jump operation is performed.

The servo processor 14 further supplies a spindle driving signal generated in accordance with the spindle error signal SPE to a spindle motor driver 17. The spindle motor driver 17 applies, for example, a three-phase driving signal to the spindle motor 6 in accordance with the spindle driving signal, so that the CLV rotation or the CAV rotation of the spindle motor 6 is performed. Also, the servo processor 14 causes a spindle driving signal to be generated in accordance with a spindle kick/brake control signal from the system controller 10, and causes an operation, such as starting, stopping, acceleration, and deceleration of the spindle motor 6 by the spindle motor driver 17, to be performed. Also, in this embodiment, when recording or reading of the unique ID to be described later is performed, control can be performed such that a predetermined number of rotations can be obtained.

Also, the servo processor 14 generates a sled driving signal in accordance with a sled error signal obtained as lower frequency components of the tracking error signal TE and in accordance with access execution control from the system controller 10, and supplies it to a sled driver 15. The sled driver 15 drives the sled mechanism 8 in accordance with the sled driving signal. Although not shown, the sled mechanism 8 comprises a mechanism formed of a main shaft which holds the optical pickup 1, a sled motor, transmission gears, etc. By driving the sled mechanism 8 in accordance with the sled driving signal by the sled driver 15, a predetermined sliding movement of the optical pickup 1 is performed.

The various operations of the servo system and the recording/reading system such as those described above are controlled by the system controller 10 formed by a microcomputer. The system controller 10 performs various processes in accordance with commands from the host computer 80.

For example, when a read command which requests the transfer of a particular piece of data recorded on the disk 90 is supplied, first, seek operation control is performed with the indicated address as a target. That is, an instruction is given to the servo processor 14, so that a seek command causes the optical pickup 1 to perform an operation for accessing the specified target address.

Thereafter, control of an operation necessary for transferring the data in the indicated data section to the host computer 80 is performed. That is, data reading, decoding, buffering, etc., from the disk 90 is performed, and the requested data is transferred.

Furthermore, when a write command is issued from the host computer 80, first, the system controller 10 causes the optical pickup 1 to move to an address at which writing is to be performed. Then, the system controller 10 causes the encoding/decoding section 12 to perform an encoding process in the above-described manner on the data transferred from the host computer 80 so that the data is converted into an EFM signal.

Then, as a result of the write data WDATA on which a waveform adjustment process is performed in the above-described manner being supplied to the laser driver 18, recording is performed.

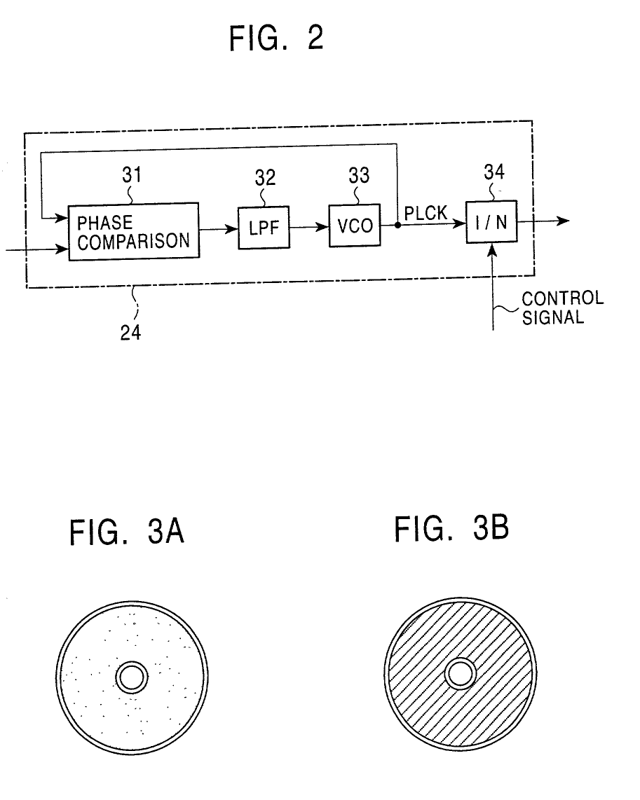

FIG. 2 is a block diagram illustrating an example of the construction of the PLL circuit 24 shown in FIG. 1.

The PLL circuit 24 comprises a phase comparator 31, an LPF (Low-Pass Filter) 32, a voltage-controlled oscillator (hereinafter referred to as the acronym “VCO”) 33, a 1/N frequency-divider 34, etc.

A read signal from the disk 90, which is an input signal to the PLL circuit 24, and a clock PLCK generated in accordance with this read signal are supplied to the phase comparator 31, that is, a loop for locking the phase by the LPF 32 and the VCO 33 is formed. That is, the phase comparator 31 detects the phase difference between the read signal and the clock PLCK and outputs it to the VCO 33, thereby allowing a clock PLCK synchronized with the phase of the read signal to be regenerated.

Furthermore, the 1/N frequency-divider 34 is capable of frequency-dividing the clock PLCK in accordance with, for example, a control signal from the system controller 10. For example, in this embodiment, frequency-dividing of the clock PLCK is performed in a case where the unique ID (identification information) is recorded by changing the line density from that of other information or in a case where a unique ID having a different line density is read, as will be described later.

Although in this embodiment, an example is described in which a disk drive unit 70 is constructed so as to be capable of performing recording and reading, for example, the disk drive unit 70 may be formed as a drive unit specialized for reading, which does not have a construction for a recording system.

2. The Type of Disk of a CD Format

FIGS. 3A and 3B schematically show the type of disk in a case where the line density is set at a reference.

FIG. 3A shows a standard-density disk in which the entire disk is set at a conventional recording density. CD-DAs, CD-ROMs, CD-Rs, and CD-RWs, which are widely used currently, correspond thereto. FIG. 3B shows a high-density disk which has been developed recently. An example thereof is of a type in which the entire disk is recorded at a high density. For example, disks of 2× density, 3× density, etc., as compared with standard-density disks, have been developed. In particular, recordable high-density disks using recording principles similar to those of CD-Rs and CD-RWs have been developed.

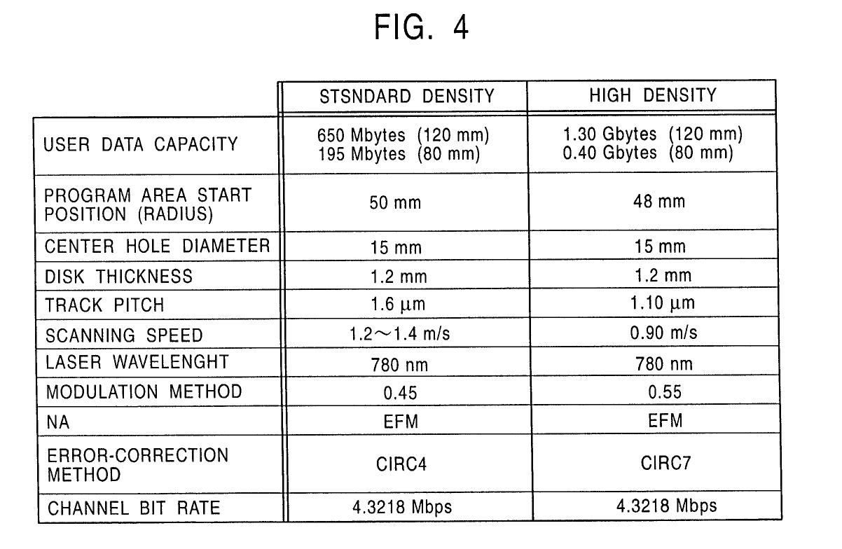

Here, various characteristics and parameters in the respective cases of a standard density and a high density are as shown in FIG. 4.

The user data capacity (main data to be recorded) is set at 650 Mbytes (disk having a diameter of 12 cm) or at 195 Mbytes (disk having a diameter of 8 cm) in the case of a standard-density disk. In the case of a high-density disk, the capacity is set at 1.30 Gbytes (disk having a diameter of 12 cm) or at 0.4 Gbytes (disk having a diameter of 8 cm), thus a capacity approximately twice as large is realized in the high-density disk.

The program area start position at which user data is recorded is specified as a position of 50 mm in a radial direction of the standard-density disk, and as a position of 48 mm in a radial direction of the high-density disk.

The track pitch is 1.6 μm in the case of a standard-density disk and is 1.10 μm in the high-density disk. The scanning speed is 1.2 to 1.4 m/s in the standard-density disk and is 0.90 m/s in the high-density disk. The NA (numerical aperture) is 0.45 in the case of a standard-density disk and is 0.55 in the high-density disk. For the error-correction method, a CIRC4 method is adopted in the standard-density disk, and a CIRC7 method is adopted in the high-density disk.

The center hole diameter, the disk thickness, the laser waveform, the modulation method, and the channel bit rate, other than the above, are the same between the standard-density disk and the high-density disk, as shown in FIG. 4.

For example, when the standard-density disk and the high-density disk of FIGS. 3A and 3B are considered, when a disk is loaded, it is necessary for the disk drive unit to determine the type of the disk. In this embodiment, a determination is made on the basis of, for example, the line density of recording data.

3. Recording Area Format

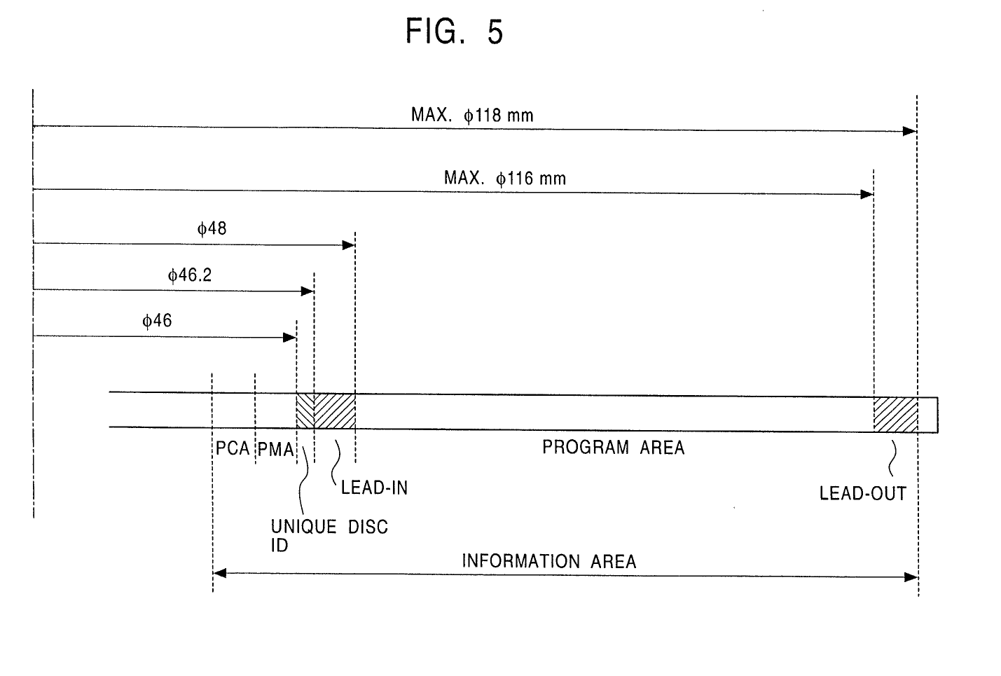

FIG. 5 is a schematic diagram in which each area formed on the writable disk 90, such as a CD-R or a CD-RW, is shown in such a manner as to correspond to the radial direction.

As shown in FIG. 5, a unique disk ID area, a program memory area (PMA), and a power calibration area (PCA) are provided in a portion inward of the lead-in area. Following the lead-in area, a program area and a lead-out area are formed.

The PCA is an area where a test recording for adjusting the output power of a laser light is performed. The PMA is an area where the table-of-contents information of the tracks is recorded so that it is temporarily held. The information recorded in the PMA will be recorded in the lead-in area later. The PCA and the PMA are areas formed on a disk corresponding to recording, and are areas accessible by a disk drive unit which is constructed as being capable of recording.

The unique disk ID area is formed adjacent to the inner radial portion of the lead-in area, and is formed as a recording area where, for example, copyright information of the contents (to be described later), as the unique ID of the disk 90, can be recorded.

In this embodiment, the disk drive unit is capable of recording a unique ID in this unique disk ID area at a line density differing from that of data recorded in another area. That is, as for the unique ID recorded on the disk, it is recorded at a line density differing from that of the other data.

Also, by recording the unique ID by using an area adjacent to the inner radial portion of the lead-in area as the unique disk ID area, the unique ID can be read smoothly following the start-up process performed when the disk 90 is loaded into the disk drive unit.

Furthermore, since the unique disk ID area is formed in an outer radial portion of the PCA and the PMA, the unique disk ID area is made into an area accessible by a disk drive unit capable of recording and a read-only disk drive unit.

The lead-in area adjacent to the outer radial portion of the unique disk ID area is an area for recording the table of contents (TOC) such as the starting address and the end address of the tracks which are units of data which is recorded in the program area, and various pieces of information for the disk 90. The program area, which is provided in an outer radial portion of the lead-in area and is used to record user data, is recorded by a drive unit which is designed for a CD-R or a CD-RW, and is used to read recorded contents in a manner similar to a CD-DA, a CD-ROM, etc.

A lead-out area is formed in an outer radial portion of the program area.

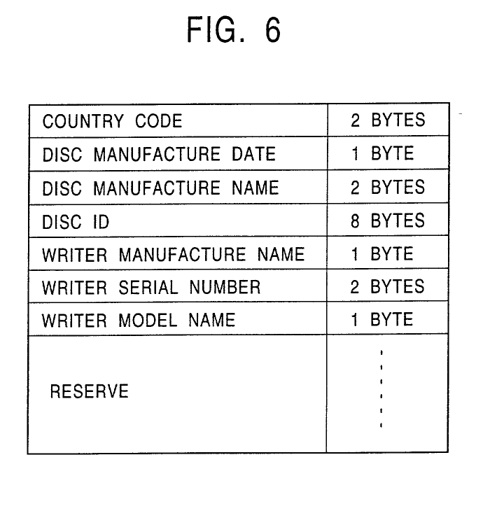

FIG. 6 is an illustration of an example of a recording area formed in the unique disk ID area. The number of bytes indicating the capacity of each piece of information is an example.

This unique disk ID area is formed as, for example, a recording area of 2048 kilobytes, for example, with the country code as the beginning. In the country code (2 bytes), information corresponding to the country or the area where the disk is produced is recorded. In the disk manufacture date (1 byte), information corresponding to the data at which the disk is produced is recorded. In the disk manufacture name (2 bytes), information corresponding to the manufacture's name which produced the disk is recorded. In the disk ID (8 bytes), the identification information of the disk is recorded. In the writer manufacture date (1 byte), information corresponding to the manufacture's name of the recording apparatus which performed recording on the disk is recorded. In the writer serial number (2 bytes), the serial number information of the recording apparatus which performed recording on the disk is recorded. In the writer model name (1 byte), information corresponding to the name of the recording apparatus which performed recording on the disk is recorded. The portions which follow are used as a reserve area.

The unique ID is formed by the information of each item recorded in the unique disk ID area which has been described above. In FIG. 6, although, for the unique ID, for example, information relating to a copyright is used as an example, for the identification information of the disk 90, other information may be recorded as necessary.

4. Subcode and TOC

The TOC recorded in the lead-in area on a disk of a CD format, and subcode, will now be described below.

The minimum unit of data which is recorded on a disk in a CD method is one frame. One block is formed by 98 frames.

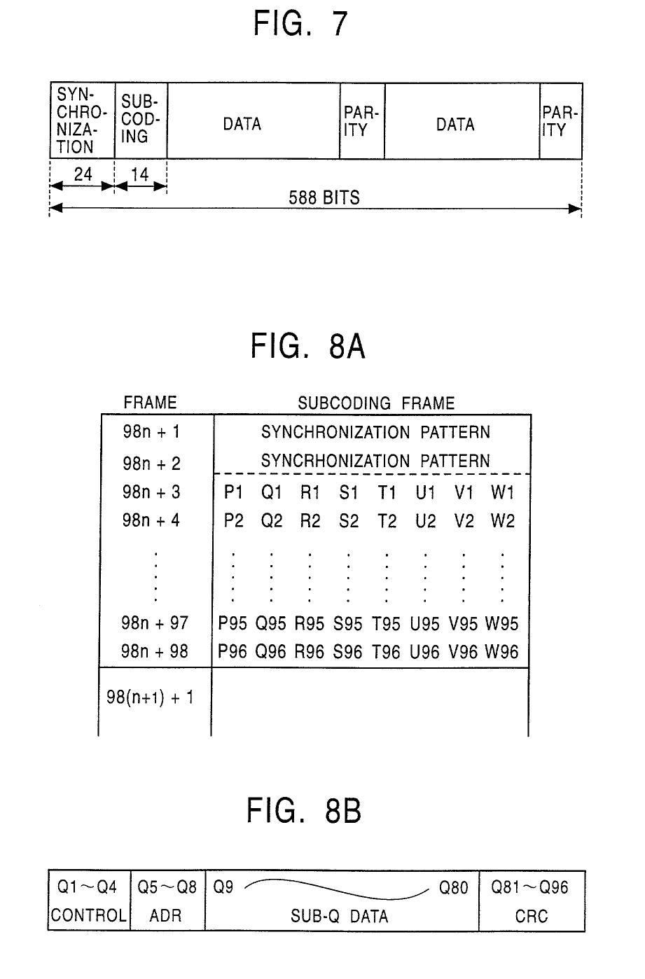

The structure of one frame is as shown in FIG. 7.

One frame is formed of 588 bits, the start 24 bits are set as synchronization data, and the following 14 bits are set as a subcode data area. Following that, data and parities are provided.

The frame synchronization signal shown in the figure represents a signal contained at intervals of a fixed length of data (frames), determined by the format of various types of disks, and is formed as a bit pattern which cannot exist in normal data. Also, the frame synchronization signal is assumed to contain a pattern of a maximum length which is possible from the type of format.

One block is formed of 98 frames in this construction, and subcode data taken out from the 98 frames is collected to form subcode data (subcoding frames) of one block such as that shown in FIG. 8A.

The subcode data from the first and second frames (frame 98n+1, frame 98n+2) of the 98 frames is used as the synchronization pattern. Then, from the third frame up to the 98th frame (frame 98n+3 to frame 98n+98), channel data, each being 96 bits long, that is, subcode data P, Q, R, S, T, U, V, and W, is formed.

Of these, for access management, etc., a P channel and a Q channel are used. However, the P channel shows only a pause portion between tracks, and finer control is performed by the Q channel (Q1 to Q96). The Q channel data of 96 bits is formed as shown in FIG. 8B.

First, the four bits of Q1 to Q4 are used as control data, and are used for the number of audio channels, emphasis, CD-ROM, and the identification of permission/nonpermission of a digital copy, respectively.

Next, the four bits of Q5 to Q8 are used as an ADR, which indicates the mode of sub-Q data. The 72 bits of Q9 to Q80 following the ADR are used as sub-Q data, and the remaining Q81 to Q96 are used as a CRC.

5. Recording of Unique ID

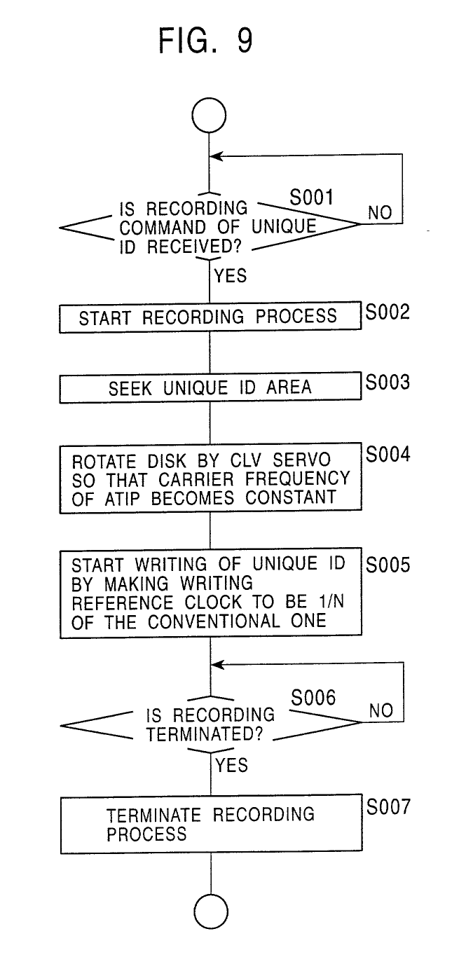

FIG. 9 is a flowchart illustrating an example of a processing steps of the system controller 10 in a case where a unique ID is recorded in the unique disk ID area. In the processing steps described below, for example, a high-density disk is used as a reference.

For example, when it is determined that a recording command instructing the recording of a unique ID is supplied from the host computer 80 (step S001), the process proceeds to an operation of recording the unique ID (step S002).

When the process proceeds to the recording operation, the system controller 10 seeks the unique disk ID area (step S003), and causes the disk 90 to rotate by a CLV servo so that the wobble carrier frequency of the ATIP becomes constant (step S004). The disk 90 is rotated, for example, with the rotation target value of the CLV servo being as a standard speed (1× speed as a high-density disk), and the system controller 10 performs servo control such that the wobble carrier frequency becomes 22.05 KHz. Furthermore, the clock PLCK for writing data is made to be 1/N of that in a case where other data (for example, the user data, etc., other than the unique ID) is recorded, and the unique ID is recorded (step S005). For example, when the writing of the other data is being performed in accordance with the clock PLCK=4.3218 MHz, the unique ID is recorded in accordance with the clock PLCK/2=2.1609 MHz, for example, which is half of that frequency.

After the recording has started in this manner, it is determined whether or not the recording has been terminated (step S006). When it is determined that the recording is finished, the recording is terminated (step S007).

In this case, if the clock during recording is denoted as W and the rotational speed of the disk is denoted as V, the following relationships can be set:

W=1/N*W0

V=V0

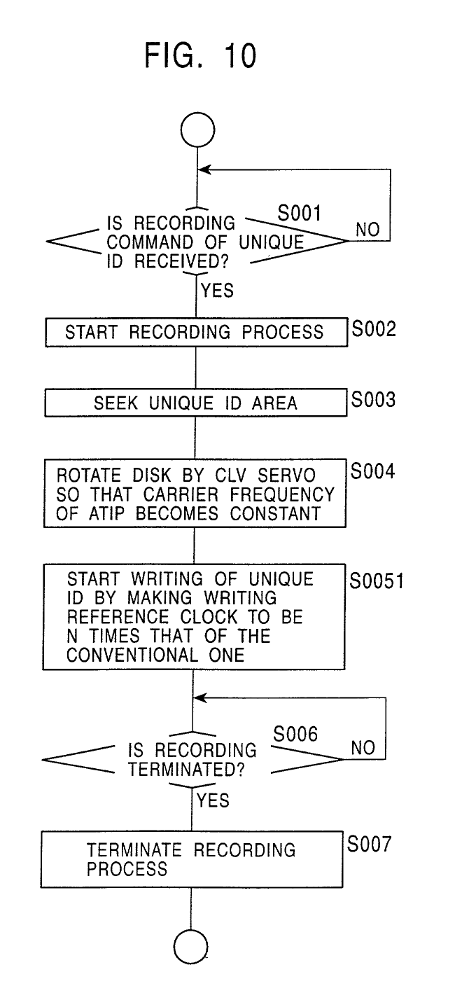

Also, for the processing step of recording the unique ID, another example shown in, for example, FIG. 10 is given. Steps S001 to S004, and steps S006 and S007 in FIG. 10 are the same processing steps as the steps shown in FIG. 9.

As is shown as step S0051 in FIG. 10, the writing of the unique ID may be started on the basis of a state in which the disk is being rotated so that the wobble carrier frequency of ATIP becomes constant, that is, on the basis of the number of rotations, which is N times the number of rotations at which other data is written, which is a reference.

In this case, in a manner similar to the above-described case, if the clock during recording is denoted as W and the rotational speed of the disk is denoted as V, the following relationships can be set:

W=W0

V=N*V0

Therefore, it is possible to record the unique ID at a line density which is the same as that in the case shown in FIG. 9.

In this manner, by performing recording by making the clock PLCK to be 1/N or by making the number of rotations of the disk N times greater, the unique ID will be recorded at a density which is 1/N of the other data. That is, by prerecording the unique ID on a copyrighted disk as described in FIG. 7, it is possible to make a differentiation from the disks for which there is no copyright.

Then, it is possible for the disk drive unit which performs reading to determine whether or not the disk is copyrighted on the basis of whether or not such a unique ID can be read.

6. Reading of Unique ID

A description will be given below of an example of a processing step of the system controller 10 in a case where a disk determination is made by reading the unique ID in the disk drive unit. In the processing step described below, for example, a disk which is formed to have a high density is used as a reference. That is, a description is given by assuming that, in the high-density disk, the line density of the data other than the unique ID is set at, for example, “1.0 times”.

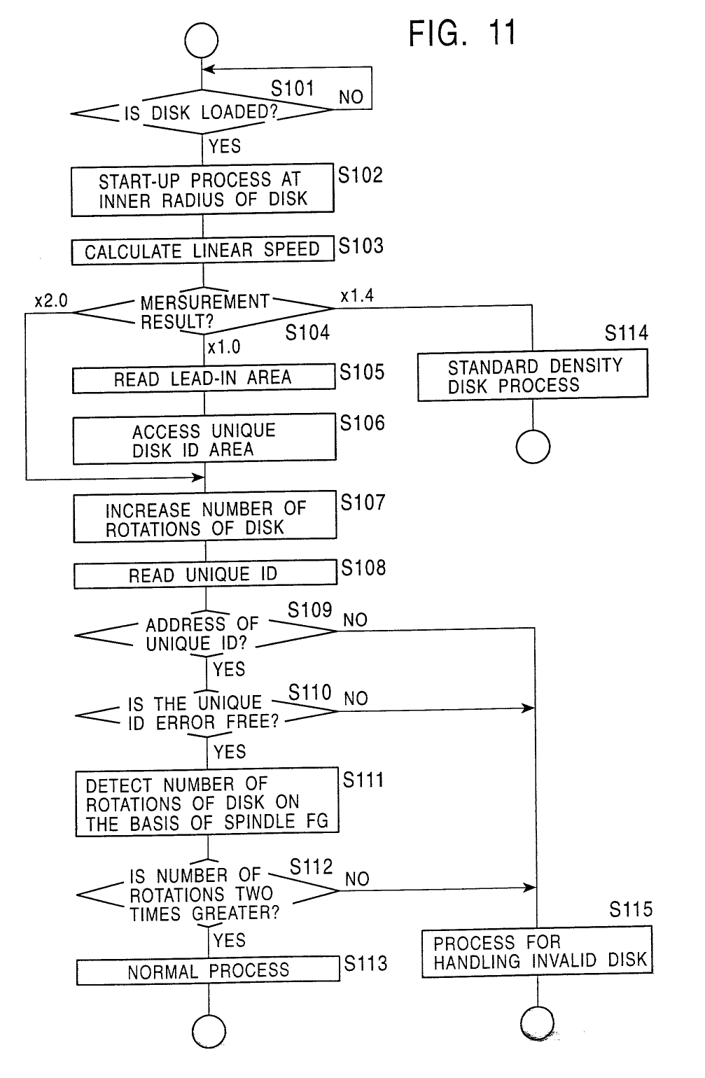

First, in accordance with the flowchart shown in FIG. 11, a processing step for making a disk determination in a state in which servo control by CLV is being performed is described.

Initially, it is determined whether or not the disk 90 is loaded (step S101). When it is determined that the disk 90 is loaded, a start-up process is performed in an inner radial portion of the disk 90 (step S102). This start-up process is a process for performing, for example, servo settling at a predetermined rotational speed with a CLV servo, pull-in settling of a focusing servo, and tracking servo settling in order to move to a state in which the reading of data from the disk 90 becomes possible.

When the various types of servos are settled, the linear speed is measured (step S103). Then, the measurement results are determined (step S104). When it is determined that the linear speed is, for example, “1.0 times”, assuming that an access to the lead-in area of the high-density disk is made, the information recorded on the lead-in area is read (step S105). Then, access to the unique disk ID area in which the unique ID is recorded is made (step S106), control is performed so that the number of rotations of the disk 90 is increased, and the unique ID recorded on the unique disk ID area is read (step S108).

Then, the address check of the unique ID is performed, and it is determined whether or not the unique ID has been recorded on the regular recording area, that is, on the unique disk ID area (step S109). Next, when the result of the address check shows to be “OK”, it is determined whether or not an error has been detected in the read unique ID (step S110). When it is determined that an error has not been detected in the unique ID, the number of rotations of the disk 90 is detected on the basis of the FG 23 (step S111). That is, in step S108, the rotational speed of the disk 90 in a case where the unique ID could be read from the regular recording area without errors is detected. Furthermore, it is determined whether or not the number of rotations of the disk 90 is N times greater (step S112). When, for example, the unique ID has been recorded at a line density which is half of the other data, it is determined whether or not the number of rotations is two times greater.

Then, when it is determined that the number of rotations of the disk 90 is N times greater, the disk is determined to be a disk on which the unique ID is recorded, and the process proceeds to the normal process (step S113).

If, for example, the address check is “NG” in step S109, an error occurred in the unique ID in step S110, or the number of rotations is not N times greater in step S112, the disk is determined to be an invalid disk, and the process proceeds to a process for handling an invalid disk (step S115).

In a case where it is determined that the linear speed is, for example, “2.0 times” in the measurement results in step S104, at the time when the start-up process (S102) is performed, assuming that an access to the unique disk ID area of a high-density disk is being made, the process proceeds to step S108, whereby the unique ID is read.

Also, when it is determined that the linear speed is, for example, “1.4 times” in the measurement results in step S104, assuming that a standard-density disk is loaded, the process proceeds to a process for handling a standard-density disk (step S114).

Where it is difficult to perform a rotational driving, for example, in accordance with a rotational speed of N times greater on the basis of the performance of the spindle motor 6, the target speed of the CLV servo control may be decreased as necessary.

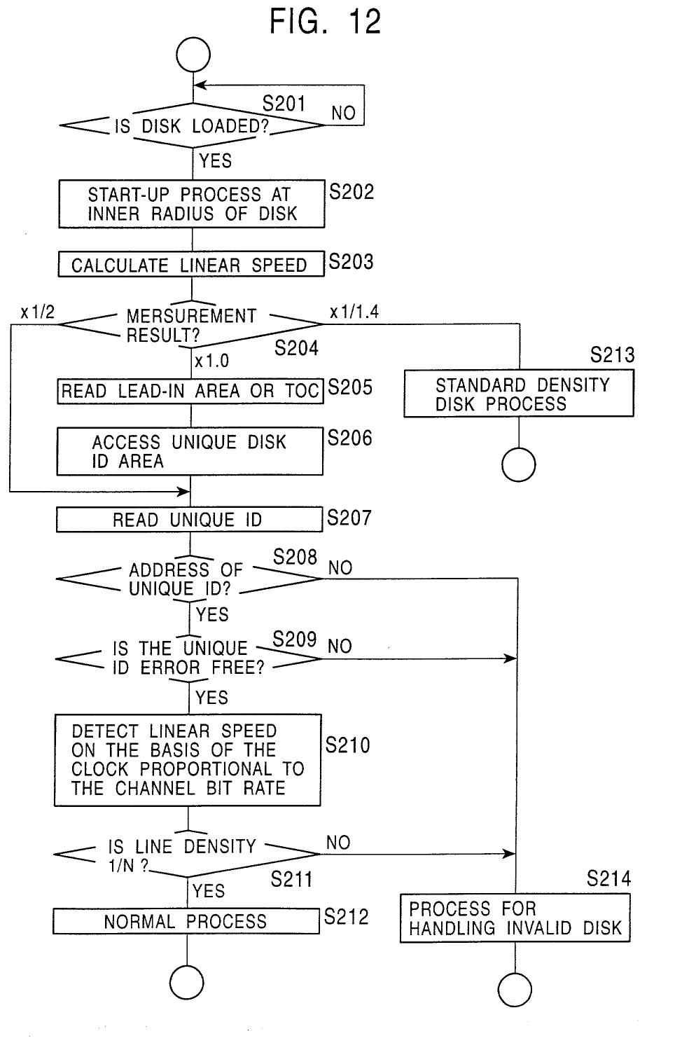

Next, in accordance with the flowchart shown in FIG. 12, a description is given below of a processing step of making a disk determination in a state in which a start-up process is performed by a CAV-based servo control.

Initially, it is determined whether or not the disk 90 is loaded (step S201). When it is determined that the disk 90 is loaded, a start-up process is performed in an inner radial portion of the disk 90 (step S202). This start-up process is, similar to the case described with reference to the flowchart of FIG. 11, a process for performing, for example, servo settling at a predetermined rotational speed with a CAV servo, pull-in settling of the focusing servo, and tracking servo settling in order to move to a state in which the reading of data from the disk 90 becomes possible.

When the various types of servos are settled, the linear speed is measured (step S203). Then, the measurement results are determined (step S204). When it is determined that the linear speed is, for example, “1.0 times”, assuming that an access to the lead-in area of a high-density disk is made, the information recorded on the lead-in area is read (step S205). Then, an access to the unique disk ID area in which a unique ID is recorded is made (step S206), and the unique ID recorded on the unique disk ID area is read (step S207).

Then, the address check of the unique ID is performed, and it is determined whether or not the unique ID has been recorded in the regular recording area, that is, in the unique disk ID area (step S208). Next, when the result of the address check shows to be “OK”, it is determined whether or not an error has been detected in the read unique ID (step S209). When it is determined that an error has not been detected in the unique ID, the line density of the recording data is detected in accordance with a clock which is proportional to the channel bit rate, for example, a clock such that the clock PLCK is frequency-divided in the PLL circuit 24 (step S210). That is, in step S210, when the unique ID can be read without errors from the regular recording area, the line density of the unique ID is detected.

In step S210, the line density of the unique ID may be detected on the basis of the intervals at which the subcode frame synchronization signal or the EFM frame synchronization signal is detected. That is, in step S210, based on the period of the read unique ID, the line density of the unique ID will be detected.

In addition, it is determined whether or not the line density of the unique ID is 1/N (step S211). For example, when it is assumed that the unique ID is recorded at a line density of half of the other data, the determination of the line density is made assuming that “N=2”.

When it is determined that the line density is 1/N, assuming that the disk is a disk on which the unique ID is recorded, the process proceeds to the normal process (step S212). Also, if, for example, the address check is “NG” in step S208, an error occurred in the unique ID in step S209, or the number of rotations is not 1/N times greater in step S211, the disk is determined to be an invalid disk, and the process proceeds to a process for handling an invalid disk (step S214).

In a case where it is determined that the linear speed is, for example, “½ times” in the measurement results in step S204, at the time when the start-up process (S202) is performed, assuming that an access to the unique disk ID area of a high-density disk is being made, the process proceeds to step S207, whereby the unique ID is read.

Also, when it is determined that the linear speed is, for example, “1/1.4 times” in the measurement results in step S204, assuming that a standard-density disk is loaded, the process proceeds to a process for handling a standard-density disk (step S213).

In FIGS. 11 and 12, a processing step on the condition that the unique ID is to be read is described. However, in a case where, for example, a disk on which a unique ID is not recorded is read, at the time when the unique ID is read in step S108 or S207, assuming that the unique ID cannot be detected, the process may proceed to a process for handling an invalid disk.

In this manner, a disk determination can be made on the basis of whether or not the unique ID recorded at a line density differing from that of the other data can be read in a predetermined recording area on a predetermined disk 90. Therefore, by prerecording the unique ID on, for example, a copyrighted disk and by making a disk determination on the basis of whether or not the unique ID could be read during reading, it becomes possible to determine the capability of reading on the basis of this determination result.

As has thus been described, the recording apparatus of the present invention is capable of recording identification information, in a predetermined area of a loaded recording medium, at a line density differing from that of data recorded in another area. Due to the different line densities in this case, recording of identification information is made possible, for example, by varying the rotational speed of the recording medium or by varying the clock frequency in a case where recording is recorded.

Therefore, since a data modulation circuit for recording identification information is not required, it is possible to construct a recording apparatus without changing hardware.

Furthermore, since the identification information is recorded in an area adjacent to an inner radial portion of a lead-in area of the recording medium, it is possible to smoothly read the identification information following a start-up process performed when the recording medium is loaded into a reading apparatus.

In the recording medium of the present invention, identification information having a line density differing from that of data recorded in another area is recorded. Therefore, it becomes possible for the reading apparatus into which the recording medium is loaded to determine the type of the recording medium.

In addition, the reading apparatus of the present invention can perform reading control corresponding to the line density at which the identification information is recorded when the identification information recorded in a predetermined recording area of the recording medium is read, and can determine the type of the recording medium on the basis of whether or not the identification information could be read.

Therefore, since a data demodulation circuit for reading the identification information is not required, there is nearly no need to change hardware.

Many different embodiments of the present invention may be constructed without departing from the spirit and scope of the present invention. It should be understood that the present invention is not limited to the specific embodiments described in this specification. To the contrary, the present invention is intended to cover various modifications and equivalent arrangements included within the spirit and scope of the invention as hereafter claimed. The scope of the following claims is to be accorded the broadest interpretation so as to encompass all such modifications, equivalent structures and functions.

What is claimed is:

1. A recording apparatus comprising:
recording means for recording identification information of a recording medium in a predetermined area of said loaded recording medium; and
a recording controller for performing control such that said identification information is recorded at a line density differing from that of another piece of information recorded in another area.

2. The recording apparatus according to claim 1, wherein said recording medium is a disk-shaped recording medium, and said predetermined area is formed in an inner radial portion adjacent to a lead-in area.

3. The recording apparatus according to claim 1, further comprising a rotation controller for controlling the rotation driving of said recording medium,
wherein said recording controller is capable of performing recording control of said identification information in a state in which said recording medium is being rotated at a speed differing from the rotational speed in a case where said other information is recorded.

4. The recording apparatus according to claim 1, further comprising a clock generator for generating a clock in a case where recording is performed on said recording medium,
wherein said recording controller is capable of performing recording control of said identification information in accordance with said clock having a frequency differing from that in a case where said other information is recorded.

5. A recording apparatus comprising:
a recording head for recording information on a disk-shaped recording medium which is loaded;
a spindle motor for driving said disk-shaped recording medium to rotate; and
a recording controller for performing control such that the identification information of said recording medium is recorded, in a predetermined area of said disk-shaped recording medium, at a line density differing from that of other information which is recorded in another area.

6. The recording apparatus according to claim 5, wherein said predetermined area is an area formed in an inner radial portion adjacent to a lead-in area.

7. A recording medium, in which identification information having a line density differing from that of information recorded in another area is recorded in a predetermined recording area.

8. The recording medium according to claim 7, wherein said recording medium is a disk-shaped recording medium, and said predetermined area is formed in an inner radial portion adjacent to a lead-in area.

9. The recording medium according to claim 7, wherein said recording medium is a disk-shaped recording medium; from the inner radial portion, a program memory area for temporarily recording and holding the table-of-contents information of user data, a lead-in area where the information recorded in the program memory area is recorded is recorded, and a program area where the user data is recorded are provided; and said predetermined area is provided between said program memory area and said lead-in area.

10. A reading apparatus comprising:
reading means for reading identification information recorded in a predetermined recording area of a loaded recording medium;
a reading controller for performing reading control corresponding to a line density at which said identification information is recorded when said identification information is read;
reading determination means for determining whether or not said identification information could be read by predetermined reading control; and
type determination means for determining the type of said recording medium on the basis of the determination result of said reading determination means.

11. The reading apparatus according to claim 10, wherein said recording medium is a disk-shaped recording medium, and said predetermined area is formed in an inner radial portion adjacent to a lead-in area.

12. The reading apparatus according to claim 10, further comprising a rotation controller for controlling the rotational driving of said recording medium, wherein said reading controller can perform reading control of said identification information in a state in which said recording medium is being rotated at a speed differing from the rotational speed in a case where another piece of information is read.

13. The reading apparatus according to claim 12, wherein said type determination means can determine the type of said recording medium on the basis of the number of rotations of said recording medium.

14. A reading apparatus comprising:
reading means for reading identification information recorded in a predetermined recording area of a loaded recording medium;
a signal generator for generating a signal based on the period of information which is read from said recording medium;
a detector for detecting the period of a signal generated by said signal generator when said identification information is being read;
density determination means for determining a line density at which said identification information is recorded on the basis of the detection result of said detection means; and
type determination means for determining the type of said recording medium on the basis of the determination result of said density determination means.

15. The reading apparatus according to claim 14, wherein said predetermined area is formed in an inner radial portion adjacent to a lead-in area.

16. A reading apparatus comprising:
a reading head for reading information recorded on a loaded recording medium;
a detector for detecting the recording line density of information recorded in a predetermined recording area of said recording medium in accordance with a reading signal of said head; and
type determination means for determining, on the basis of the detection result of said detector, the line density of recording medium identification information which is prerecorded in an area provided in an inner radial portion of a lead-in area of said recording medium and for determining the type of said recording medium.

17. A recording medium determination method comprising:
an access step for accessing a predetermined recording area of a loaded recording medium;
a reading control step for performing reading control corresponding to a line density of identification information recorded in said predetermined recording area;
a reading step for reading said identification information in a state in which said reading control is being performed; and
a type determination step for determining the type of recording medium on the basis of whether or not said identification information could be read.

18. The recording medium determination method according to claim 17, wherein said predetermined area is formed in an inner radial portion adjacent to a lead-in area.

19. The recording medium determination method according to claim 17, wherein said reading control step is a step in which said recording medium is rotated at a speed differing from the rotational speed in a case where another piece of information is read.

20. The recording medium determination method according to claim 19, wherein said type determination step is a step in which the type of said recording medium is determined on the basis of the number of rotations of said recording medium.

21. A recording medium determination method comprising:
an access step for accessing a predetermined recording area of a loaded recording medium;
a reading step for reading identification information recorded in said predetermined area;
a detection step for detecting the period of said identification information;
a line density determination step for determining a line density at which said identification information is recorded on the basis of said period; and
a type determination step for determining the type of said recording medium on the basis of said line density.

22. The recording medium determination method according to claim 21, wherein said predetermined area is formed in an inner radial portion adjacent to a lead-in area.
